(19) United States
(12) Patent Application Publication
(10) Pub. No.: US 2003/0108054 A1
(43) Pub. Date: Jun. 12, 2003

(54) Method and apparatus for connecting an IP-based client to a server through an OSI network

(75) Inventors: Robert R. Williams, Nepean (CA); Milan M. Kantor, Nepean (CA)

Correspondence Address: OGILVY RENAULT, 1981 MCGILL COLLEGE AVENUE, SUITE 1600, MONTREAL, QC, H3A2Y3, CA

(73) Assignee: Nortel Networks Limited, St. Laurent, QC (CA)

(21) Appl. No.: 10/003,520

(22) Filed: Dec. 6, 2001

(51) Int. Cl. H04L 12/28; H04L 12/56

(52) U.S. Cl. 370/401

(57) ABSTRACT

IP packets are conveyed through an OSI network by encapsulating the IP packets in OSI packets. When an IP session is started, an OSI destination address is discovered by broadcasting the encapsulated IP packet to every OSI network element that supports a TCP/IP gateway. Tables are maintained to track IP session data for routing subsequent packets associated with an IP session.

### CROSS-REFERENCE TO RELATED APPLICATIONS

This is the first application filed for the present invention.

### MICROFICHE APPENDIX

Not applicable.

### TECHNICAL FIELD

The invention relates to data transport over an Open System Interconnection (OSI) network and, in particular, to a method and apparatus for transporting IP packets over an OSI network to link IP-based devices.

### BACKGROUND OF THE INVENTION

In recent years, optical networks that operate under the OSI protocol have used complicated hardware and software that is located remotely from a network operation center (NOC). Personnel, such as field engineers, need consolidated system information for tuning new equipment or running maintenance on equipment at remote locations. Full-scale access to an operation center helps reduce the time required to install and maintain network equipment. Field engineers typically work in small regions, usually at a central office, but they remote access to network management facilities in order to be efficient. Access today is done through a serial port on a laptop using a TCP/IP protocol. Modems are not always available at remote sites, where phone lines are frequently required for voice communications. Mobile phone modem access may solve the problem of communication, but cannot provide sufficient transfer speeds to support data connections. The absence of LAN connectivity and phone access often forces field engineers to use the phone lines in hotel rooms or the like to achieve sufficient speed of connection.

The most logical and effective way for connecting with system management facilities is an Ethernet connection between the optical network and a field engineer's computer. Ethernet connections provide sufficient data transfer speed, but the use of different communications protocols and hardware connectivity problems prevent Ethernet connections from being available at all remote network element sits. Furthermore, many network elements do not have an Ethernet interface, so Ethernet connectivity would require new hardware deployment and incur extra cost for customers. Another solution is an IP to OSI gateway that could translate IP client packets to OSI protocol and vice versa. Such a gateway is difficult to design, due to the nature of the complex infrastructure of the network management facilities.

Consequently, there is a need for a cost-effective solution that can provide a TCP/IP connection between a remote computer and network management facilities without deployment of new hardware or installation of complicated software on network elements or network management facilities.

### SUMMARY OF THE INVENTION

It is therefore an object of the invention to provide a simple, cost-effective solution for transferring IP packets through an OSI network between an IP client and an IP server.

It is a further object of the invention to provide a solution for transferring IP packets through an OSI network that does not require an addition of new hardware.

In accordance with a first aspect of the invention, there is provided apparatus for connecting IP-based devices through an OSI network that includes a plurality of network elements, comprising: a plurality of OSI network elements interconnected by at least one optical fiber for transmitting information through the network using OSI packets; at least first and second network elements having a TCP/IP interface for sending and receiving IP packets; a table containing information about addresses of IP packets that are received and sent, an OSI address of OSI packets that encapsulate IP packets that are received and sent and a timestamp associated with each record in the table, the timestamp representing a time of sending an OSI encapsulated IP packet to an address in the record; an application adapted to originate the destination OSI address of a network element associated with an IP destination address of an IP packet, encapsulate the IP packet in an OSI packet, remove an IP packet from an OSI packet, and maintain the table.

In accordance with a second aspect of the invention, there is provided a method for connecting IP-based devices through an OSI network having a plurality of network elements, comprising steps of: receiving at a first network element a first IP packet to be sent via the OSI network to a second network element that is adapted to deliver the first packet to an IP destination address in the IP packet; encapsulating the first IP packet in an OSI packet and broadcasting the OSI packet to each network element that supports a TCP/IP gateway; receiving the OSI packet at each of the network elements, recording an OSI origination address extracted from the OSI packet, removing the encapsulated IP packet, and recording the IP origination and destination addresses; forwarding the IP packet over a TCP/IP link supported by the TCP/IP gateway.

The invention therefore permits IP packets to be transferred through the OSI network without the addition of hardware. In one embodiment of the invention, the IP packets are encapsulated in connectionless network protocol (CLNP) OSI packets, and a special value is inserted into a network layer selector (NSEL) to permit a receiving network element to efficiently discriminate OSI packets that encapsulate IP packets.

### BRIEF DESCRIPTION OF THE DRAWINGS

Further features and advantages of the present invention will become apparent from the following detailed description, taken in combination with the appended drawings, in which:

FIG. 1 is a schematic diagram of an optional network that can be adapted to provide IP packet transmission between two IP devices that are coupled to the optical network;

FIG. 2 is a schematic diagram illustrating the optical network shown in FIG. 1 originating a destination address of a network element that serves an IP device having the destination address of the IP packet.

FIG. 3 is a schematic diagram illustrating the optical network shown in FIG. 1 that is returning a response IP packet to the source IP device;

FIG. 4 is a schematic diagram of an OSI packet that encapsulates an IP packet;

FIG. 5 is a schematic diagram of a look-up table maintained by network elements of the optical network; and

FIGS. 6A and 6B are a flowchart of principal steps that are performed by network elements when transmitting IP packets through the OSI optical network.

It will be noted that throughout the appended drawings, like features are identified by like reference numerals.

### DETAILED DESCRIPTION OF THE PREFERRED EMBODIMENT

The present invention permits IP packets to be transferred through an OSI optical network to enable an IP exchange between two IP devices coupled to the OSI network.

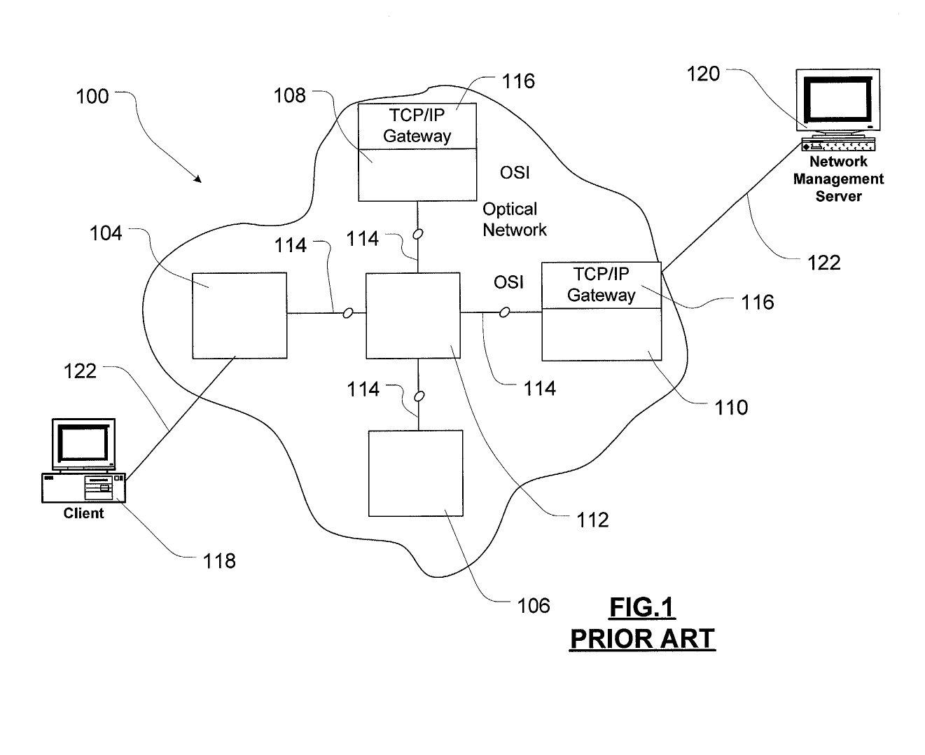

FIG. 1 schematically depicts an exemplary optical network 100 that operates under the Open System Interconnection (OSI) protocol. The optical network 100 includes a number of network elements 104, 106, 108, 110 and 112 connected directly or indirectly to each other by optical fibers 114. The optical network 100 may include a large number of network elements that are geographically distributed across a large territory. Each network element has its own OSI address and supports data exchange with other network elements 104, 106, 108, 110 and 112 of the optical network 100 using the OSI protocol. Under the OSI protocol, the data exchange occurs using data packets. In the example shown in FIG. 1, the optical network 100 supports a data exchange between a client computer 118 and a network management server 120. Each has an Ethernet TCP/IP connection, or any other connection medium that supports a TCP/IP connection to the optical network. The client 118 and the network management server 120 also have unique IP addresses.

Each network element 104, 106, 108 and 110 functions identically to transmit and route data through the optical network 100. The network elements 104, 106, 108, 110 and 112 may also support a variety of interfaces for the connection of external devices. For example, the network elements 108 and 110 support gateways for Ethernet TCP/IP connections. The network element 104 has an Ethernet TCP/IP interface. The network elements 106 and 112 may also support an Ethernet TCP/IP interface.

The optical network 100 is managed by a network management application that monitors network resources, provides operative management of the network resources, tracks network status, posts alarms for network management personnel when abnormal conditions are detected in the optical network 100, and facilitates other functions related to the optical network management.

The invention enables the delivery of data in TCP/IP format via the optical network 100 using the OSI protocol. The structure of a TCP/IP and an OSI packet are not identical. Consequently, a TCP/IP packet cannot be transferred through the optical network 100 as an IP packet.

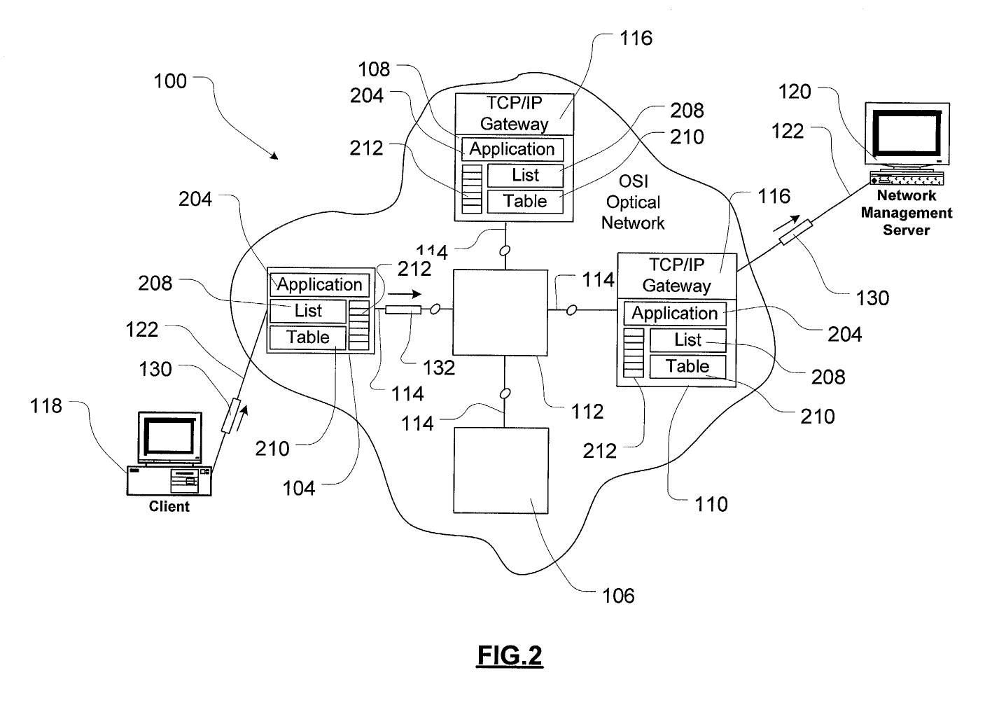

As shown in FIG. 2, the client 118 sends an IP packet 130 that contains data to be delivered. In the example illustrated in FIG. 2, the destination address of the IP packet 130 is the IP address of the network management server 120. The IP address of the client 118 is automatically inserted as an origination address in the IP packet 130. The network element 104 has, in addition to software that has the primary function of managing the transfer of OSI packets through the optical network 100, an application 132 that monitors and classifies all incoming packets from external sources. If an incoming packet is determined to be an IP packet, the packet is encapsulated into an OSI packet 132 that has to be delivered to the network element 110, which is connected to the network management server 120 that has an IP address that matches the destination address of the IP packet 130.

Prior to exchanging IP packets between the two IP devices, the client 118 and the network management server 120 in this example, the network element 104 has to originate the OSI address of the network element 110 that serves the network management server 120. In accordance with the invention, the network element 104 originates the OSI address of the network element 110 by encapsulating the received IP packet 130 in an OSI packet that is sent to each network element in the optical network 100 that supports a gateway 116. In the example illustrated in FIG. 2, the OSI packet 132 that encapsulates the IP packet 130 is broadcast to all of the network elements 106, 108, 110 and 112. Only the network elements 108 and 110 perform additional processing. Network elements 108 and 110 are adapted to extract the IP packet 130 from the OSI packet 132 and to send the IP packet 130 via the respective gateways 116. As an alternative, if broadcast capability is not available in the optical network 100, a list 208 of OSI addresses of network elements that support a TCP/IP gateway can be maintained. In that case, the OSI packet 132 is sent only to those network elements in the list 208.

In accordance with an embodiment of the invention, the IP packets are encapsulated in connectionless network protocol (CLNP) OSI packets. As is known in the art, CLNP is a lower layer OSI protocol that carries upper-layer data and error indications. In order to facilitate discrimination of OSI packets that encapsulate IP packets, a predetermined network layer selector (NSEL) is inserted in a header of each OSI packet that carries an IP packet. This permits the CLNP packet to be forwarded through the OSI network using normal OSI routing mechanisms. As will be understood by persons skilled in the art, however, other delivery mechanisms can be used and the invention is not limited to the use of CLNP packets for delivery.

Each network element with a gateway 116 is provisioned with an application 204 for analyzing incoming packets from the OSI network 100. The incoming packets are classified. Each network element of the optical network 100 may receive OSI packets, IP packets, or packets of other types. A received OSI packet may be a standard OSI packet that has to be delivered to an OSI destination address, or an OSI packet that encapsulates an IP packet. The network elements 108 and 110 are adapted to remove an encapsulates IP packet from an OSI packet; extract the destination/origination addresses of the IP and OSI packets; write these addresses along with a timestamp as a record in a look-up table; and forward the IP packet via the gateway.

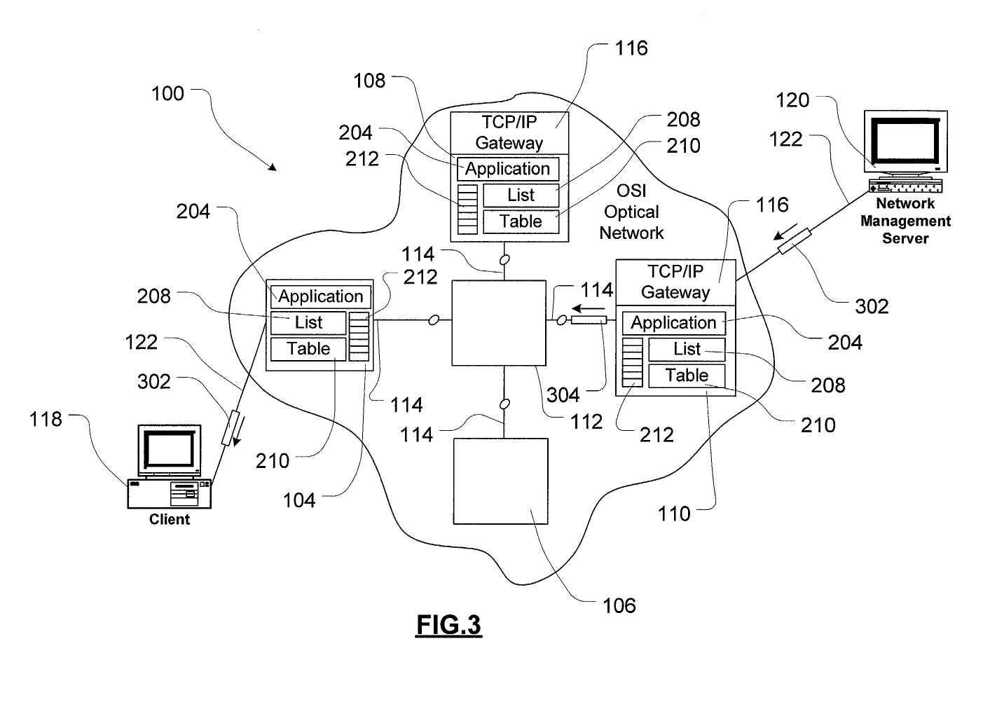

Only the network element 110 will receive an IP packet 302 (FIG. 3) in response to the IP packet 130 (FIG. 2), because the IP device which is the network management server 120 served by the network element 110 has the same IP address as the destination address of the IP packet 130 (FIG. 2). When the response packet 302 is received at the network element 110 the application 204 determines that it is an IP packet and extracts the destination address of the response IP packet 302. The look-up table 210 of the network element is searched to locate the address of the network element that is associated with the destination address of the response IP packet 302. When the destination OSI address is located, the response IP packet 302 is encapsulated in an OSI packet 304 and the OSI destination/origination addresses are inserted in that OSI packet. Then the OSI packet 304 is forwarded to the destination address, and the timestamp is updated in the look-up table 210. If a matching address is not found in the look-up table 1210, the IP packet 302 is treated as described above and forwarded to all other network elements.

The OSI packet 304 having encapsulated the response IP packet 302 is forwarded to the destination address, which is, in the example illustrated in FIGS. 2 and 3, the network element 104.

The network element 104 receives the OSI packet 304 containing the response IP packet 302. That OSI packet 304 is segregated from the standard OSI packets transferred through the OSI network 102. The application 204 at the network element 104 removes the response IP packet 302 from the OSI packet 304, and extracts the destination/origination addresses of the IP packet 302 and the OSI packet 304. The look-up table 204 is searched for the origination/destination addresses of the response IP packet. If those addresses match a destination/origination address pair in the records of the look-up table 210, the origination address of the OSI packet 304 is written in the record as an OSI destination address. At the same time, the timestamp in the record is updated. The next incoming IP packet having a destination address that matches the IP address of the network management server 120 is encapsulated in an OSI packet and set to the destination address that is specified in the look-up table 210. The two look-up tables 210 at the client side network element 104 and at the server side network element 110 provide the address information for IP packet exchange between two IP devices: the client 118 and the network management server 120. The applications 204 at the network elements 104 and 110 preferably also provide an option for controlling the bit rate of the IP packet exchange for protecting the resources of the optical network 100 from overflow. The bit rate can be determined by an administrator of the optical network 100. The bit rate of IP packet exchange is regulated by delaying processing of incoming IP packets at the receiving network element. In the preferred embodiment, the bit rate is regulated by delaying the processing of the IP packets by storing incoming IP packets in a buffer 212 (FIG. 3) at the client side network element 104. If the bit rate of incoming IP packets exceeds a predefined level, the IP packets are delayed in the buffer to keep the bit rate at the predefined level.

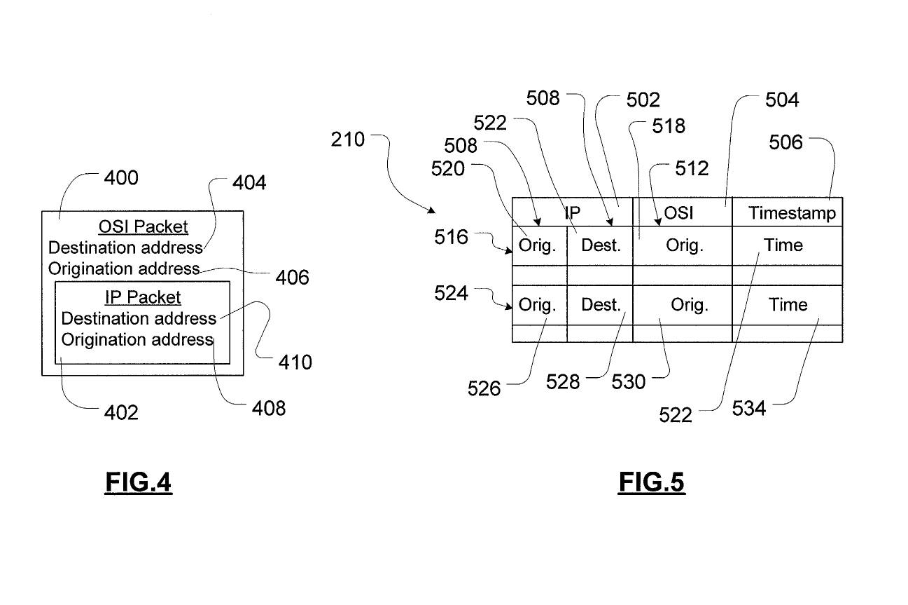

FIG. 4 is a schematic diagram of a structure of an OSI packet 400 having an encapsulated IP packet 402. The OSI packet 400 can be transferred within the OSI optical network from one network element to another. Every OSI packet 400 includes an origination address 404 and destination address 406. An OSI packet may contain any data that is to be transferred through the OSI optical network 100. In the example shown, the OSI packet contains the encapsulated IP packet 402. The IP packet 402 also includes an origination address 408 and a destination address 410.

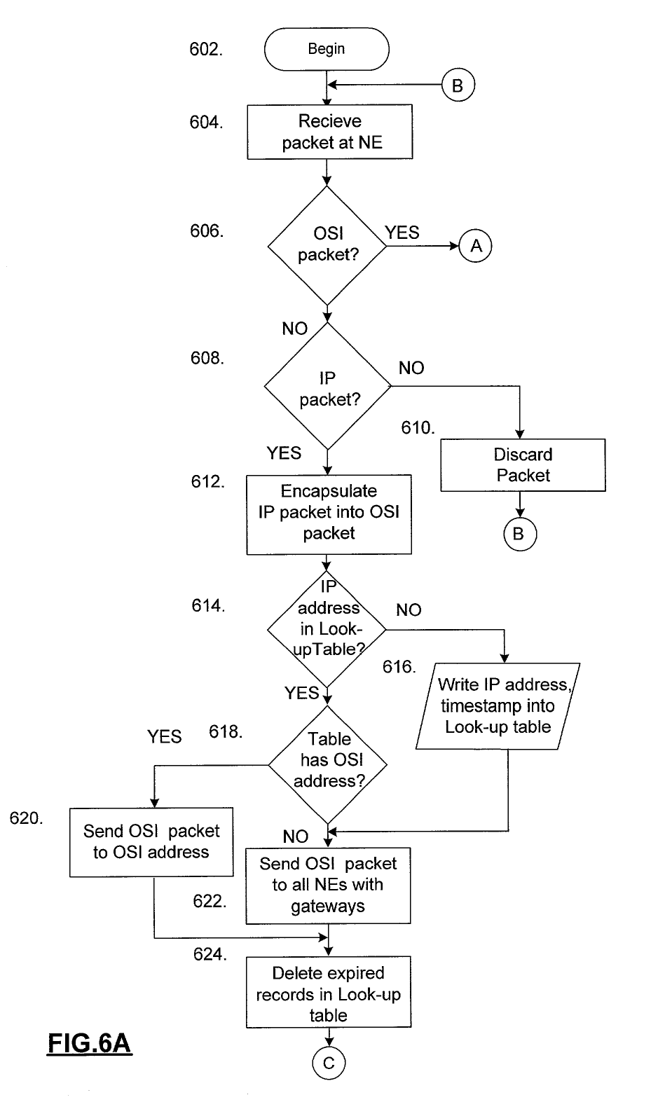

The network elements are provisioned with a look-up table to track packets that are sent and received. FIG. 5 shows an example of an embodiment of the look-up table. The look-up table 210 stores information about addresses of received OSI packets that encapsulate an IP packet and include columns for origination 508 and destination 508 addresses of the IP devices; the origination 512 OSI addresses of the network elements that originate and terminate the OSI messages and a timestamp 506. The timestamp 506 is used to track connection activity so that aborted or terminated sessions can be deleted from the table after a predetermined interval of inactivity.

The record 516 illustrates an example of information that is recorded in the look-up table 210 by the network element 104 when it received and processed the first IP packet. The cells 520 and 522 of the record 516 contain information about the destination and origination addresses of the first IP packet. That information is extracted from the IP packet header. The cell 518 contains the origination address of the network element 104. The cell 522 is a timestamp that stores the actual time of the last update to the record 516.

The record 524 is an example of a record in which all of the cells 526, 528, 530, 532 and 534 are filled. The record 524 includes all the information required to deliver IP packets associated with a particular connection. The record 524 illustrates an example of a record in the lookup table 210 of a network element 104, 110 (FIG. 2) after the destination OSI address has been determined. The records in the look-up table on the client side network element 104 and the server side network element 110 are associated with the same IP addresses. Of course, the origination address of the OSI and IP packets in the lookup table record on the client side network element 104 are the destination addresses in the look-up table record on the server side network element, and vice versa.

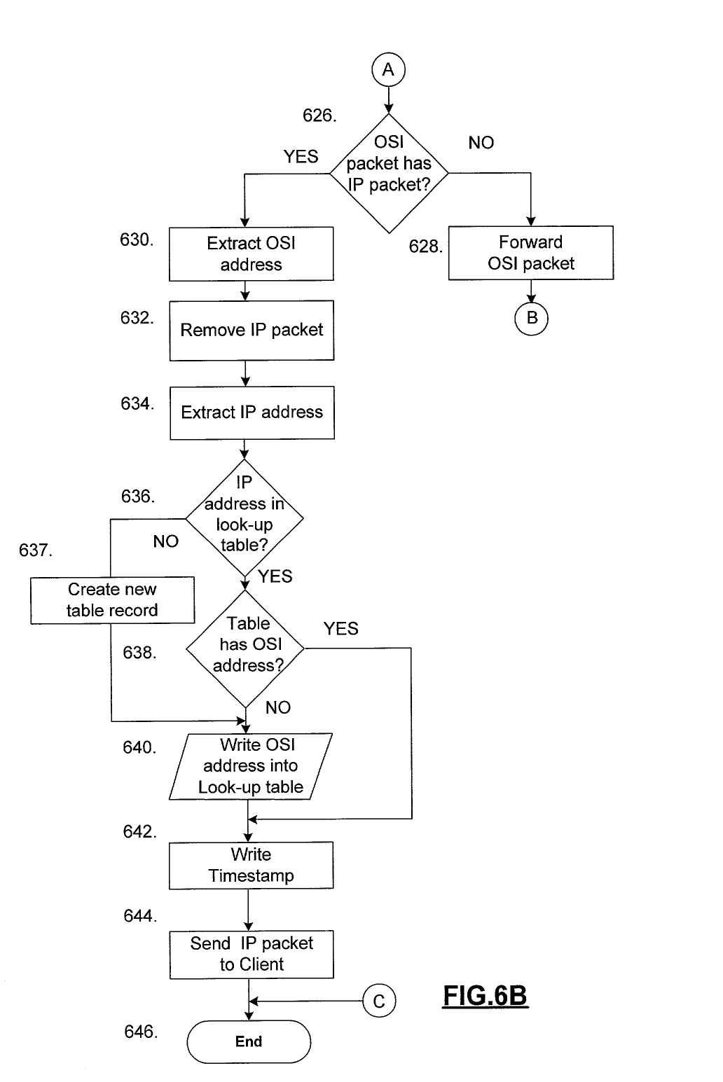

To better understand the processing of incoming packets at the network elements 104 and 108 depicted in FIG. 2 and FIG. 3, FIGS. 6A and 6B provide a flowchart of the steps that are performed at the respective network elements. Each network element in the OSI network is adapted to receive and process packets. After beginning at step 602, the network element waits for incoming packets. In step 604, when the network element receives a packet, the network element determined the type of packet that was received. In step 606, the network element determines whether the incoming packet is an OSI or a non-OSI packet. If the incoming packet is an OSI packet, the network element performs steps shown in FIG. 6B beginning at connector A. If the incoming packet is an IP packet (step 608), then that packet in step 612 will be encapsulated in the OSI packet. If it is determined that the incoming packet is not an IP packet, the packet is discarded (step 610). To deliver the incoming IP packet to the destination address of the IP packet, it is necessary to originate the OSI address of the network element that serves the IP device that has the IP address in the destination address field of the IP packet to be delivered. In step 614 the destination IP address is searched in the look-up table at the network element. If the destination IP address does not match any records, the address along with a timestamp is written (step 616) in the look-up table. If the destination IP address is located in the look-up table, in step 618, the look-up table is searched for the presence of the OSI address of the network element that serves the destination IP address. If the OSI address is found in step 618, the OSI packet is sent to the OSI address stored in the look-up table. If the look-up table does not contain the OSI address, the OSI packet encapsulating the IP packet is broadcast to all network elements that support a TCP/IP gateway. As explained above, each record in the look-up table includes a timestamp. The timestamp is used to track the activity of connections tracked in the look-up table. The timestamps of all records in the look-up table at the network element are periodically inspected (step 624). Any record having a timestamp that was last updated more than a predetermined time ago (10 minutes, for example) is deleted from the table.

As explained above, if the network element determines, in step 606, that an incoming packet is an OSI packet, in step 626 the network element determines whether the OSI packet encapsulates and IP packet. If the OSI packet does not encapsulate an IP packet, the OSI packet is forwarded to the destination address of the OSI packet (step 628). If the OSI packet encapsulates an IP packet, the OSI destination/origination addresses are extracted in step 630; the IP packet is removed from the OSI packet (step 632); and the IP destination/origination addresses are extracted in step 634.

In step 636, the extracted destination/origination IP addresses are searched for in the look-up table. If in step 686 it is determined that the destination/origination IP addresses do not match any records, a new look-up table record is created and the destination/origination IP addresses of the IP packet are written to the table in step 637. If the destination/origination addresses are located in the look-up table, the table record is examined to determine whether the OSI origination address has been recorded in the look-up table (step 638). If not, the OSI origination address is recorded in the table (step 640. Otherwise, if it is determined in step 638 that a record that matches the destination/origination IP addresses also contains an OSI address that is associated with the origination address of the IP packet, then the timestamp is updated (step 642) the IP packet is forwarded to the destination IP device, in step 644, and the process ends (step 646).

The invention therefore provides a simple, effective, economical solution for permitting TCP/IP connections to be set up across an OSI optical network. Network administration and other data communications functions are thereby enhanced.

The embodiments of the invention described above are intended to be exemplary only. The scope of the invention is therefore intended to be limited solely by the scope of the appended claims.

We claim:

1. A method for connecting Internet Protocol (IP) devices through an Open System Interconnection (OSI) network that includes a plurality of network elements, comprising the steps of:
receiving at a first network element a first IP packet having IP origination and destination addresses to be forwarded through the OSI network to a second network element that is adapted to forward the IP first packet toward the IP destination address;
encapsulating the first IP packet in an OSI packet and broadcasting the OSI packet to each network element in the OSI network that supports a TCP/IP gateway;
receiving the OSI packet at each of the network elements that support a TCP/IP gateway, recording OSI origination address, removing the encapsulated IP packet and recording IP origination and destination addresses; and
forwarding the IP packet over a TCP/IP link supported by the TCP/IP gateway.

2. A method as claimed in claim 1, further comprising steps of:
on receiving an IP packet having corresponding IP origination/destination addresses on the TCP/IP link, encapsulating the IP packet in an OSI packet, inserting the recorded OSI address as a destination address of the OSI packet, and forwarding the OSI packet through the OSI network to enable a direct exchange of IP packets between the origination and destination IP addresses.

3. A method as claimed in claim 1, wherein the step of encapsulating the first IP packet comprises a step of encapsulating the first IP packet in a connectionless network protocol (CLNP) packet and setting a network layer selector (NSEL) value in a header of the OSI packet to a predetermined value used to indicate CLNP packets that carry IP packets.

4. A method as claimed in claim 1, wherein the step of broadcasting further comprises a step of using a predefined list of addresses of the network elements that support a TCP/IP gateway when a broadcast mechanism is not available.

5. A method as claimed in claim 1, wherein the step of recording the origination and destination addresses further comprises steps of creating and maintaining a look-up table.

6. A method as claimed in claim 5, wherein the steps of recording OSI and IP addresses further comprises steps of recording a timestamp associated with each record and maintaining records in the look-up table for a predefined period of time after an exchange of IP packets has ceased.

7. A method as claimed in claim 6, wherein the step of maintaining records in the look-up table further comprises a step of periodically examining the timestamp of each record in the look-up table, and deleting any record having a timestamp that is prior to a predetermined time.

8. A method as claimed in claim 7, further comprises a steps of:
receiving an OSI packet that includes an encapsulated response IP packet at the first network element;
extracting the OSI origination address of the second network element from the OSI packet;
removing the response IP packet from the OSI packet and origination/destination addresses of the response IP packet;
searching the look-up table of the first network element for a record in the look-up table having IP origination/destination addresses that match the IP destination/origination addresses of the response IP packet;
recording the OSI origination address of the second network element as a destination address in the record, and updating a timestamp associated with the record if a match is found; and
forwarding the response IP packet over a TCP/IP link connected to the first IP gateway.

9. A method as claimed in claim 8, wherein the steps of receiving and forwarding packets further comprises a step of updating the timestamp in the look-up tables of the first and the second network elements.

10. A method as claimed in claim 8, further comprises a step of controlling a bit rate at which IP packets are transferred between two network elements.

11. A method as claimed in claim 10, wherein the step of controlling the bit rate further comprises a step of storing OSI packets with encapsulated IP packets in a buffer of the respective first and second network elements.

12. A method as claimed in claim 8, wherein the step of receiving further comprises steps of:
receiving at the first network element a subsequent IP packet having IP origination and destination addresses;
extracting the destination address of the a subsequent IP packet;
searching in the look-up table of the first network element for a record that has the destination address of the subsequent IP packet;
retrieving the destination address of the OSI network element that is associated with the destination address of the subsequent IP packet;
updating the timestamp in the record;
encapsulating the subsequent IP packet in an OSI packet; and
inserting the retrieved OSI address as an OSI destination address in the OSI packet and forwarding the OSI packet with the subsequent IP packet to the second network element.

13. A method as claimed in claim 12, wherein the step of forwarding the OSI packet further comprises steps of:
receiving an OSI packet that includes the encapsulated subsequent IP packet at the second network element;
removing the subsequent IP packet from the OSI packet;
extracting the IP origination/destination addresses from the second IP packet;
searching the look-up table of the second network element for a record in the table having IP origination/destination addresses that match those of the subsequent IP packet;
updating a timestamp if a match is found; and
forwarding the subsequent IP packet over the TCP/IP link.

14. Apparatus for connecting Internet Protocol (IP) devices through an Open System Interconnection (OSI) network having a plurality of network elements, comprising:
a plurality of OSI network elements interconnected by at least one optical fiber for transmitting information through the OSI network using OSI packets;
at least first and second network elements including:
a TCP/IP interface for sending and receiving IP packets;
a table for recording information about addresses of IP packets that are received and sent, an origination address of OSI packets with encapsulated IP packets that are received and sent, and a timestamp associated with each record in the table, the timestamp representing a time associated with sending or receiving an IP packet to an IP origination/destination address in the record; and
an application adapted to:
originate the destination OSI address of a network element associated with an IP destination address of or an IP packet,
encapsulate IP packets in OSI packets,
extract IP packets from an OSI packet, and
maintain the table.

15. An apparatus as claimed in claim 14, wherein the application at the first network element to originate the destination OSI address of the second network element that is associated with a destination address of IP packets is further adapted to:
extract origination and destination addresses from the first IP packet;
record the origination and destination addresses of the first IP packet and a timestamp;
encapsulate the first IP packet that is received at the first network element in a first OSI packet and broadcast the first OSI packet to each network element;
receive a second OSI packet with an encapsulated second IP packet from the second network element that is associated with the IP destination address of the first IP packet;
extract the OSI origination address of the second OSI packet;
remove the second IP packet from the second OSI packet; and
extract the IP origination and destination addresses of the second IP packet, search the table of the first network element for a record that has a destination address of the first IP packet and write the origination address of the second OSI packet as an OSI destination address in the record along with a time stamp.

16. An apparatus as claimed in the claim 15, wherein the application of the second network element is further adapted to:
receive the first OSI packet that includes the encapsulated first IP packet at the second network element;
remove the first IP packet from the first OSI packet;
extract the OSI origination address from the first OSI packet and IP origination/destination addresses from the first IP packet;
record the origination address of the first OSI packet and the IP origination/destination addresses of the first IP packet along with a timestamp;
forward the first IP packet over a TCP/IP link.

17. An apparatus as claimed in claim 14, wherein the application is further adapted to encapsulate the IP packets in connectionless network protocol (CLNP) OSI packets.

18. An apparatus as claimed in claim 17, wherein the application is further adapted to insert a predetermined network selector (NSEL) value into a header of the CLNP packet to indicate that the CLNP packet carries an IP packet.

19. An apparatus as claimed in claim 17, wherein the application of the first network element is further adapted to:
receive a subsequent IP packet having IP origination and destination addresses;
extract the destination address of the subsequent IP packet;
search the table for a record that contains the IP destination address of the subsequent IP packet;
retrieve the OSI address of the OSI network element that is associated with the IP destination address of the subsequent IP packet;
update the timestamp in the record;
encapsulate the subsequent IP packet in an OSI packet; and
insert the retrieved OSI address as a destination address in the OSI packet and forward the OSI packet with the encapsulated IP packet to the second network element.

20. An apparatus as claimed in claim 19, wherein the application of the second network element is further adapted to:
receive an OSI packet that includes the encapsulated subsequent IP packet at the second network element;
remove the subsequent IP packet from the OSI packet;
extract the OSI origination address from the OSI packet and IP origination/destination addresses from the subsequent IP packet;
search the table for a record containing the IP origination/destination addresses of the subsequent IP packet;
update a timestamp if a match is found; and
forward the subsequent IP packet over the TCP/IP link.

21. An apparatus as claimed in claim 14, wherein a network element receives and sends IP packets using an Ethernet connection through a TCP/IP gateway.

22. An apparatus as claimed in claim 14, wherein the application is further adapted to periodically examine the timestamp of each record in the table and delete any record having a timestamp that is prior to a predetermined time.

23. An apparatus as claimed in the claim 14, wherein the application is further adapted to control a bit rate at which IP packets are transferred between two network elements.
